(19) United States
(12) Patent Application Publication
(10) Pub. No.: US 2011/0111703 A1
(43) Pub. Date: May 12, 2011

(54) Synchronization Method for Wireless Link and X-Ray System Using Such a Method

(75) Inventor: Nicolas Claverie, Tullins (FR)

(73) Assignee: TRIXELL S.A.S., Moirans (FR)

(21) Appl. No.: 12/994,717

(22) PCT Filed: Apr. 15, 2009
(86) PCT No.: PCT/EP2009/054456

§ 371 Date: Jan. 26, 2011

(30) Foreign Application Priority Data
May 27, 2008 (FR) 0802873

(51) Int. Cl. H04B 7/00

(52) U.S. Cl. 455/66.1

(57) ABSTRACT

A synchronization method for a wireless link between a base station and a mobile cassette of an X-ray system is provided. The base station includes an X-ray generator and the cassette includes an X-ray detector. According to the invention, the method includes steps for the exchange of messages between the base station and the cassette, the exchanges initiating timers in the base station and the cassette, a radiation sequence and an image sequence being executed at the end of the respective timers. The invention makes it possible to subject a patient to a dose of X-rays only if said dose can be perceived and recorded by the X-ray detector, the radiation sequence being executed after the exchanges of messages.

The invention relates to a synchronization method between a base station comprising an ionizing radiation source, such as, for example, an X-ray tube, making it possible to generate an X-ray and a mobile cassette comprising an X-ray detector making it possible to supply an image dependent on the X-ray received. The invention relates in particular to a synchronization method for a wireless link. The invention also relates to an X-ray system comprising a base station, a mobile cassette and wireless communication means between the base station and the cassette. Such a system can be used in numerous applications such as, for example, medical radiology and non-destructive testing.

In the past, X-ray systems were bulky and largely immobile. The object had to be positioned relative to the X-ray system to obtain an image of its content or of its composition. With the emergence of solid-state detectors, for example described in the French patent application FR 2 796 239, the detector has become less bulky and it has become possible to move the detector relative to an object that remains fixed. A solid-state detector notably comprises a scintillator and a plurality of photosensitive elements usually arranged in a matrix. The scintillator is interposed between the X-rays and the photosensitive elements to convert the X-rays into optical rays in the band of wavelengths to which the photosensitive elements are sensitive. Each photosensitive element is formed by a photosensitive diode mounted in series with an element with switch function such as a diode or a transistor and is connected between a row conductor and a column conductor. During the image-taking phase, the photosensitive elements are exposed to a signal to be picked up and during the reading phase, a read pulse is successively applied to the row conductors to read the quantity of charges accumulated during the image-taking. For medical radiology in particular, digital detectors have been produced in the form of mobile cassettes that can now be placed in the immediate proximity of a patient for whom a radiological image is to be taken, notably when the patient's state of health prevents him from moving to a room reserved for radiology.

Firstly, the cassette was linked to the base station by a wired link. For the acquisition of a radiological image, the base station sent signals to the cassette to order the start and end of the acquisition of the radiation, the time interval between the start and the end of the acquisition of the radiation being called acquisition window. The wired link provided for perfect synchronization between the X-ray source and the X-ray detector but restricted the mobility and ease of use of the X-ray system. Consequently, the wired link was replaced by a WiFi-type wireless link, “WiFi” being the commercial name for the series of standards IEEE 802.11, in which “IEEE” is the acronym for “Institute of Electrical and Electronics Engineers”.

However, the wireless links based on an IEEE 802.11 standard did not allow for synchronization between the various elements. In particular, transmission delays between the base station and the cassette may prevent synchronization between the X-ray source and the X-ray detector. This desynchronization may be reflected in an offset between the generation of an X-ray by the radiation source and its detection by the X-ray detector. In the case where the radiation begins before the start of its detection, a dose of X-rays is sent to the cassette while the X-ray detector does not record any radiological image. Consequently, the patient is unnecessarily exposed for the period situated between the start of the radiation and the start of its detection. Similarly, in the case where the radiation continues after the end of its detection, the patient is unnecessarily exposed for the period situated between the end of the detection of the radiation and the end of its generation. In the latter case, the radiological image may be degraded, particularly if the X-ray detector is a solid-state detector and it is exposed to the X-rays during the reading phase of the accumulated charge quantities.

Moreover, the transmission between the base station and the cassette may fail. In the particular case where the transmission fails when the base station sends a radiological image acquisition request to the X-ray detector, a dose of X-rays is sent to the cassette although the X-ray detector records no radiological image. The patient is thus exposed unnecessarily to this dose of X-rays. Similarly, if the signal ordering the end of the acquisition is not received by the cassette, the X-ray detector may record a radiation which is not intended for the radiological image concerned, thus degrading this image. A transmission failure between the base station and the cassette is all the more probable when the radio powers transmitted in a medical environment are strictly limited in order, notably, not to disturb neighboring electro-medical systems.

One aim of the invention is notably to overcome all or some of the abovementioned drawbacks by proposing an X-ray system that ensures good transmission between the base station and the cassette. To this end, the subject of the invention is a synchronization method between a base station and a mobile cassette of an X-ray system, the base station comprising an X-ray generator and the cassette comprising an X-ray detector. According to the invention, the base station and the cassette are wirelessly linked and the method comprises the following steps:
sending, from the base station, an image request to the cassette and simultaneously initiating, in the base station, a first timer of a predetermined maximum duration Tₘₐₓ,
upon receipt of the image request by the cassette, sending, from the cassette, an acknowledgement message to the base station and simultaneously initiating a second timer of a duration T₁ in the cassette,
at the end of the second timer, executing an image sequence by the X-ray detector,
in the case where the base station receives the acknowledgement message before the expiry of the first timer:
   initiating, in the base station, a third timer of a duration T₂,
   at the end of the third timer, executing a radiation sequence by the X-ray generator for a predetermined duration T_{ray}.

In other words, the method comprises steps for the exchange of messages between the base station and the cassette, the exchanges initiating timers in the base station and the cassette, a radiation sequence and an image sequence being executed at the end of the respective timers.

Another subject of the invention is an X-ray system, characterized in that it comprises:
a base station comprising an X-ray generator,
a mobile cassette comprising an X-ray detector,
wireless communication means between the base station and the cassette,
means for sending, from the base station, an image request to the cassette,
means for initiating a first timer of a duration Tₘₐₓ in the base station simultaneously with the sending of the image request,
means for sending an acknowledgement message from the cassette to the base station upon receipt of the image request by the cassette,
means for initiating a second timer of a duration T₁ in the cassette, simultaneously with the sending of the acknowledgement,
means for ordering, at the end of the second timer, an image sequence for a predetermined duration Tᵢₘₐ,
means for initiating a third timer of a duration T₂ in the base station in the case where the base station receives the acknowledgement message before the expiry of the first timer,
means for ordering, at the end of the third timer, a radiation sequence for a predetermined duration T_{ray}.

One notable advantage of the invention is that it makes it possible to subject a patient to a dose of X-rays only if the X-rays emitted by the X-ray source can be perceived and recorded by the X-ray detector in order to provide a radiological image.

The invention will be better understood, and other advantages will become apparent, from reading the detailed description of an embodiment given as an example, the description being given in light of the attached drawings in which:

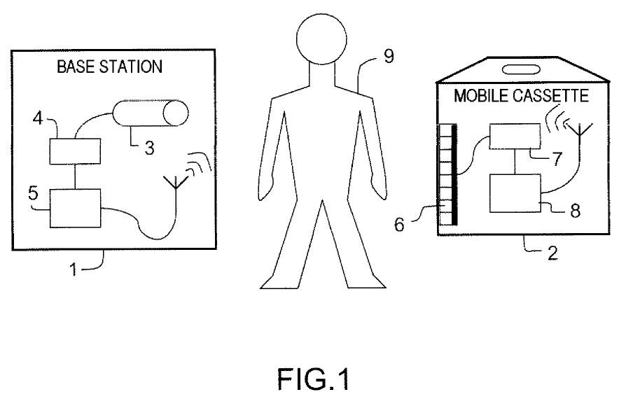

FIG. 1 represents a block diagram of an X-ray system according to the invention,

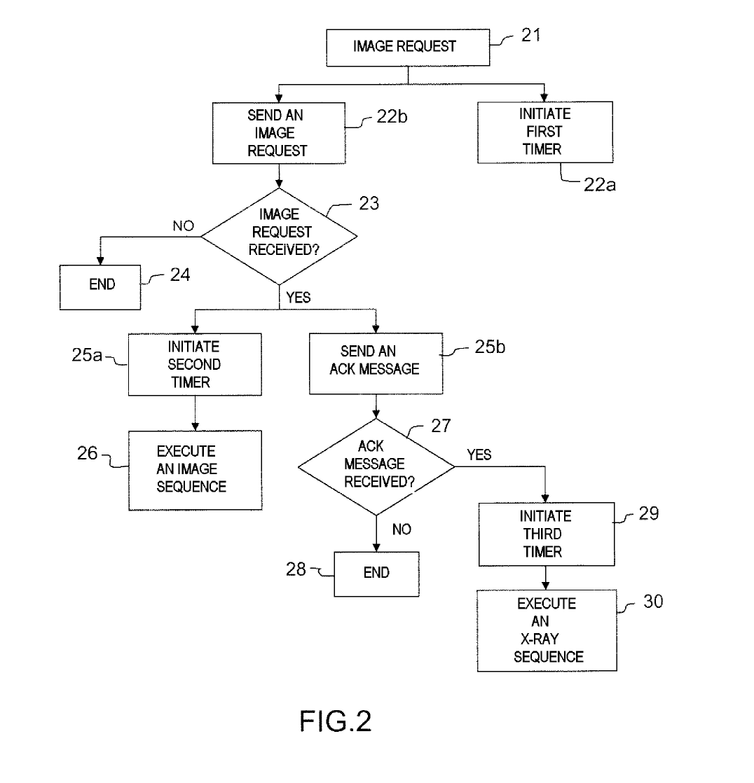

FIG. 2 represents a flow diagram of the synchronization method according to the invention,

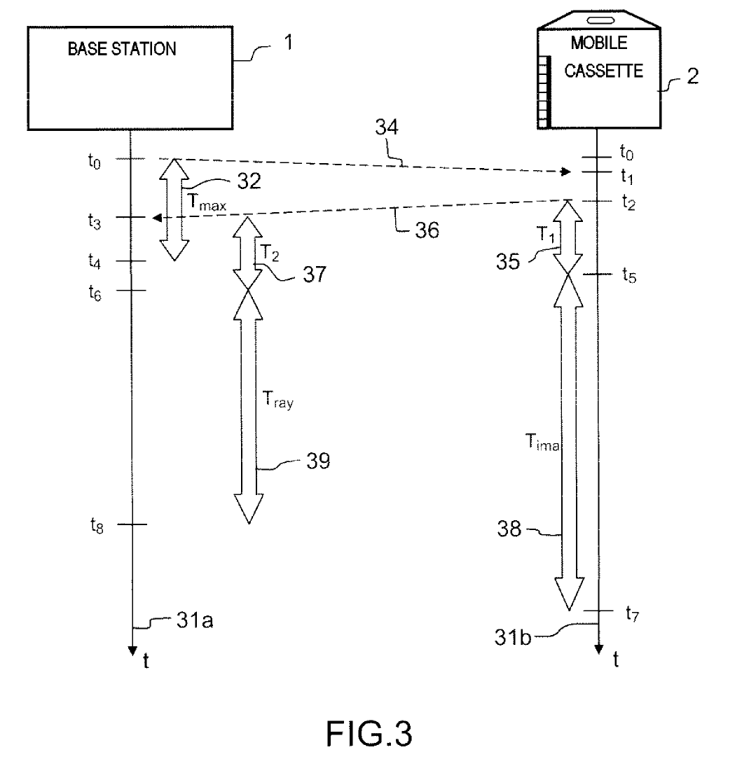

FIG. 3 represents, in a timing diagram form, an exemplary implementation of the synchronization method according to the invention.

FIG. 1 represents a block diagram of an X-ray system according to the invention. Hereinafter in the description, it will be assumed that the X-ray system is used for medical purposes, in the presence of a patient for whom a radiological image is to be obtained. However, the invention may equally be applied to other fields of radiological imaging, for example industrial. The X-ray system comprises a base station 1 and a mobile cassette 2. The base station 1 comprises an X-ray generator 3 managed by a radiation management module 4. The radiation management module 4 is linked to a radio module 5 enabling dialog between the base station 1 and the cassette 2.

The cassette 2 comprises an X-ray detector 6 linked to a detection management module 7. The X-ray detector 6 is, for example, produced in the form of a flat panel. It is designed to be able to generate a radiological image from the radiation emitted by the X-ray generator 3. The detection management module 7 is itself linked to a radio module 8.

The radio modules 5 and 8 form wireless communication means between the base station 1 and the cassette 2. These wireless communication means enable data to be transferred equally from the base station 1 to the cassette 2 and from the cassette 2 to the base station 1. The data transferred relate for example to radiological image acquisition requests, acknowledgement messages (ACK) or radiological images obtained by the X-ray detector 6. According to a particular embodiment, the radio modules 5 and 8 exchange data by using a transfer protocol based on an IEEE 802.11 standard. The instantaneous emitted radiation power can be limited in order to minimize disruption to neighboring electro-medical systems.

A patient 9 may be situated between the base station 1 and the cassette 2. Because of the wireless communication means, the cassette 2 can easily be moved close to the patient 9 in order to take a radiological image of a particular part of the patient 9. Advantageously, the X-ray generator 3 is separate from the base station 1 and linked to the latter by a wired link in order to facilitate the positioning of the X-ray generator 3 and that of the X-ray detector 6 relative to the patient 9.

FIG. 2 represents a flow diagram of the synchronization method according to the invention. In a step 21, a user of the X-ray system requests the acquisition of a radiological image from the base station 1. The image acquisition request is transmitted to the radiation management module 4, which, in a step 22a, initiates, in the base station 1, a first timer of a predetermined maximum duration Tₘₐₓ and, simultaneously, in a step 22b, transmits an image request to the cassette 2, in particular to the detection management module 7 via the radio modules 5 and 8. The timer consists, for example, in decrementing by one unit, every millisecond, a value contained in a memory. This value is determined in order to obtain the desired duration Tₘₐₓ, for example of the order of 300 milliseconds. The timer of duration Tₘₐₓ may obviously be obtained according to any other method without in any way departing from the framework of the invention. In particular, the expression “timer” should also be understood to mean an increasing count of a variable between an origin value and a destination value, the count being stopped when the variable reaches the destination value. In a step 23, a check is carried out to ensure that the image request has been correctly received by the cassette 2. If the image request has not been received, the synchronization method is terminated in a step identified by the reference 24 and no radiation will be emitted by the X-ray generator 3. If the image request is received by the cassette 2, its detection management module 7, in a step 25a, initiates a second timer of a duration T₁ in the cassette 2 and, simultaneously, in a step 25b, sends an acknowledgement message (ACK) to the radiation management module 4 via the radio modules 5 and 8. The second timer can be implemented in a manner similar to the first timer of duration Tₘₐₓ. Similarly, the second timer may be obtained by any means. In particular, it may consist of a series of operations for which the execution time is equal to the duration T₁. This series of operations may notably be used to prepare the cassette 2 for an image sequence. At the end of the second timer, the detection management module 7 sends a signal to the X-ray detector 6 to execute, in a step 26, an image sequence, for a duration Tᵢₘₐ. This duration Tᵢₘₐ corresponds to the acquisition window, in other words to the time during which the X-ray detector 6 is required to record the radiation that reaches it. The duration Tᵢₘₐ depends primarily on the time during which a radiation is emitted by the X-ray generator 3. According to a particular embodiment, the duration Tᵢₘₐ is predetermined, an exchange between the base station 1 and the cassette 2 then no longer being necessary after the start of the image sequence to terminate this image sequence. Advantageously, the duration Tᵢₘₐ is sent by the base station 1 at the same time as the image request. In a step 27, a check is carried out to ensure that the ACK message has been correctly received by the base station 1 before the expiry of the first timer of duration Tₘₐₓ. If it has not been received before the expiry of the first timer, the synchronization method is terminated in a step identified by the reference 28 and no radiation will be emitted by the X-ray generator 3. If the ACK message is received by the radiation management module 4 before the expiry of the first timer, a third timer of a duration T₂ is initiated in the base station 1. This step is referenced 29 in FIG. 2. At the end of the third timer, the radiation management module 4 sends a signal to the X-ray generator 3 to execute, in a step 30, a radiation sequence for a predetermined duration T_{ray}. This duration T_{ray} corresponds to the time during which the X-ray generator 3 must emit an X-ray. It is determined by a radiologist on the basis of several parameters, notably the part of the patient subjected to the X-rays and the morphology of the patient. The duration T_{ray} is generally less than the duration Tᵢₘₐ of the image sequence in order to ensure that all the radiation is recorded by the X-ray detector 6. In other words, the duration T_{ray} is included in the duration Tᵢₘₐ. The duration T_{ray} is generally between half a second and a few seconds.

According to the invention, the transmission between the base station 1 and the cassette 2 is checked before executing a radiation sequence and the patient 9 is not subjected to a dose of radiation unless the transmission is correct. In the case where the cassette 2 receives the image request but the ACK message is not received by the base station 1, an image sequence is executed without a radiation being emitted.

In a particular embodiment, the information relating to the X-ray received by the X-ray detector 6, for example represented in the form of charges accumulated in photosensitive elements, are read after the end of the radiation sequence. This embodiment prevents the X-ray detector 6 from receiving X-rays during the reading phase. This is obtained in particular by virtue of the first, second and third timers. The radiological image that is thus read can be transmitted to the base station 1 via the radio modules 5 and 8 in order to be analyzed.

FIG. 3 represents an exemplary implementation of the method according to the invention. A first time axis 31a makes it possible to identify the various times concerning the base station 1 and a second time axis 31b makes it possible to identify the times concerning the cassette 2. For improved legibility, the time axes 31a and 31b are represented separately; however, the various instants involved are identified relative to one and the same instant t₀.

Upon the image acquisition request at the instant t₀, the first timer 32 of a maximum duration Tₘₐₓ is initiated. Simultaneously, the image request 34 is sent to the cassette 2. The cassette 2 receives this image request 34 at an instant t₁, the duration t₁−t₀ corresponding to the transmission delay between the base station 1 and the cassette 2. At an instant t₂, or after a duration t₂−t₁ corresponding to a processing time for the image request 34, the second timer 35 of duration T₁ is initiated. At this same instant t₂, the ACK message 36 is sent to the base station 1 which receives it at an instant t₃, the duration t₃−t₂ corresponding to the transmission delay between the cassette 2 and the base station 1. In this example, it is assumed that the ACK message 36 is received before the expiry of the timer 32 occurring at an instant t₄. Consequently, the third timer 37 of duration T₂ is initiated.

The instants at which the second and third timers 35 and 37 expire are respectively denoted t₅ and t₆. Since the durations T₁ and T₂ are greater, in a ratio from 1 to 10, than the transmission times between the base station 1 and the cassette 2, in particular the duration t₃−t₂, the durations T₁ and T₂ may be equal without introducing any significant offset between the instants t₅ and t₆.

At the instant t₅, the image sequence 38 begins, to continue until an instant t₇, or for the duration Tᵢₘₐ. Similarly, at the instant t₆, the radiation sequence 39 begins, to continue until an instant t₈, or for the duration T_{ray}.

According to the invention, the durations T₁ and T₂ are substantially equal, for example of the order of 100 milliseconds, in order to expire substantially at the same time. However, because of the transmission duration (t₃−t₂) between the cassette 2 and the base station 1, the image sequence 38 always begins before the radiation sequence 39. Because of this, all the X-rays emitted at the start of the radiation sequence 39 is received by the X-ray detector 6.

According to a particular embodiment, the duration Tᵢₘₐ of the image sequence 38 is equal to the sum of the duration T_{ray} of the radiation sequence 39 and the duration Tₘₐₓ. This particular embodiment enables the X-ray detector 6 to receive all the X-ray emitted during the duration T_{ray}. Consequently, the patient 9 is not subjected unnecessarily to the X-rays and the X-ray detector 6 no longer receives X-rays during its reading phase.

1. A synchronization method between a base station and a mobile cassette of an X-ray system, the base station comprising an X-ray generator and the cassette comprising an X-ray detector, the base station and the cassette being wirelessly linked, the method comprising the following steps:
sending, from the base station, an image request to the cassette and simultaneously initiating, in the base station, a first timer of a predetermined maximum duration Tₘₐₓ,
upon receipt of the image request by the cassette, sending, from the cassette, an acknowledgement message to the base station and simultaneously initiating a second timer of a duration T₁ in the cassette,
at the end of the second timer, executing an image sequence by the X-ray detector,
in the case where the base station receives the acknowledgement message before the expiry of the first timer:
initiating, in the base station, a third timer of a duration T₂,
at the end of the third timer, executing a radiation sequence by the X-ray generator for a predetermined duration T_{ray}.

2. The method of claim 1, wherein the image sequence is executed for a predetermined duration Tᵢₘₐ, the duration T_{ray} being included in the duration Tᵢₘₐ.

3. The method of claim 2, wherein the duration Tᵢₘₐ is equal to the sum of the durations T_{ray} and the duration Tₘₐₓ.

4. The method of claim 1, wherein, in the case where the image request is not received by the cassette, the method is terminated, with the radiation sequence not being executed.

5. The method of claim 1, wherein, in the case where the acknowledgement message is not received by the base station before the expiry of the maximum duration Tₘₐₓ, the method is terminated, with the radiation sequence not being executed.

6. The method of claim 1, wherein the durations T₁ and T₂ of the second and third timers are substantially equal.

7. The method of claim 1, wherein the base station and the cassette each comprise a radio module allowing for a wireless link in accordance with the IEEE 802.11 standard.

8. The method of claim 1, wherein, after the end of the radiation sequence, the method includes reading the information relating to the X-rays received by the X-ray detector.

9. An X-ray system, comprising:
a base station comprising an X-ray generator,
a mobile cassette comprising an X-ray detector,
wireless communication means between the base station and the cassette,
means for sending, from the base station, an image request to the cassette,
means for initiating a first timer of a duration Tₘₐₓ in the base station simultaneously with the sending of the image request,
means for sending an acknowledgement message from the cassette to the base station upon receipt of the image request by the cassette,
means for initiating a second timer of a duration T₁ in the cassette, simultaneously with the sending of the acknowledgement,
means for ordering, at the end of the second timer, an image sequence for a predetermined duration Tᵢₘₐ,
means for initiating a third timer of a duration T₂ in the base station in the case where the base station receives the acknowledgement message before the expiry of the first timer,
means for ordering, at the end of the third timer, a radiation sequence for a predetermined duration T_{ray}.
